(19) United States
(12) Patent Application Publication
(10) Pub. No.: US 2026/0177204 A1
(43) Pub. Date: Jun. 25, 2026

(54) PRESSURE VESSEL CONFIGURED TO STORE FLUID

(71) Applicant: TOYOTA JIDOSHA KABUSHIKI KAISHA, Toyota-shi (JP)

(72) Inventors: Osamu Sawai, Okazaki-shi (JP); Youjirou Iriyama, Toyota-shi (JP)

(73) Assignee: TOYOTA JIDOSHA KABUSHIKI KAISHA, Toyota-shi (JP)

(21) Appl. No.: 19/369,801

(22) Filed: Oct. 27, 2025

(30) Foreign Application Priority Data
Dec. 5, 2024 (JP) 2024-212564

(51) Int. Cl. F17C 1/16

(52) U.S. Cl. CPC F17C 1/16; F17C 2201/0138; F17C 2203/0604; F17C 2203/0621; F17C 2203/066; F17C 2221/012; F17C 2221/016; F17C 2221/017; F17C 2221/033; F17C 2221/035; F17C 2223/0153

(57) ABSTRACT

A pressure vessel configured to store fluid is provided. The pressure vessel includes a liner for the pressure vessel. The liner includes a plurality of body portions and a plurality of connection portions. Each of the body portions is in the form of an elongated tubular body. Each of the connection portions connects two adjacent ones of the body portions in series, and is configured to be bent to fold the body portions. The connection portions include at least one low-elastic-modulus connection portion that is separate from the adjacent body portions and that has a lower elastic modulus than the adjacent body portions.

### CROSS-REFERENCE TO RELATED APPLICATION

This application claims priority to Japanese Patent Application No. 2024-212564 filed on Dec. 5, 2024. The disclosure of the above-identified application, including the specification, drawings, and claims, is incorporated by reference herein in its entirety.

### BACKGROUND

### 1. Technical Field

The technique disclosed in the present specification relates to pressure vessels configured to store fluid.

### 2. Description of Related Art

In a conventionally known pressure vessel for storing fluid, a liner has a structure in which tubular body portions and tubular connection portions are alternately arranged (Japanese Unexamined Patent Application Publication (Translation of PCT Application) No. 2018-519480 (JP 2018-519480 A)). The pressure vessel is configured by folding and aligning the body portions through bending at connection portions. In this type of pressure vessel, the volume of the connection portions is typically reduced in order to achieve a more compact size when stored, while ensuring a sufficient fluid storage capacity. Specifically, the connection portions are formed to have a smaller diameter than the body portions.

### SUMMARY

For example, in some cases, a liner of such a pressure vessel is obtained from a continuous tubular workpiece having a uniform diameter. In such cases, a preform is formed by alternately forming body-portion regions having a predetermined diameter and bend-portion regions having a smaller diameter than the body-portion regions, while feeding the workpiece. Thereafter, the preform is bent at the bend-portion regions to form the liner.

However, since the preform is formed such that the bend-portion regions have a smaller diameter, the bend-portion regions become about 2.5 times as thick as the body-portion regions. This may make it difficult to perform bending when forming the liner from the preform. The difficulty in bending may result in reduced productivity of the pressure vessel or deformation of its internal space. To address such issues, the diameter of the bend-portion regions has been increased in some cases.

The present specification provides a pressure vessel including a bent portion in which issues associated with bending at the bent portion are reduced.

The present specification is embodied in a pressure vessel configured to store fluid. According to one aspect, the pressure vessel includes a liner for the pressure vessel. The liner includes a plurality of body portions and a plurality of connection portions. Each of the body portions is in the form of an elongated tubular body. Each of the connection portions connects two adjacent ones of the body portions in series, and is configured to be bent to fold the body portions. The connection portions include at least one low-elastic-modulus connection portion that is separate from the adjacent body portions and that has a lower elastic modulus than the adjacent body portions.

In this pressure vessel, the low-elastic-modulus connection portion is separate from the adjacent body portions, and is therefore allowed to have an intended low elastic modulus. Since a bending process is performed at the low-elastic-modulus connection portion, the bending can be easily performed. Therefore, a decrease in productivity of the pressure vessel and the occurrence of collapse due to difficulties in the bending process are reduced. In addition, an increase in volume of the connection portion is reduced, so that the connection portion is made more compact.

In another aspect of the pressure vessel, the low-elastic-modulus connection portion may include a bent portion and tapered portions located on both sides of the bent portion and directly connected to the adjacent body portions. The low-elastic-modulus connection portion may be configured, throughout its entire length, as a layer structure including a resin material that is the same as or common with a resin material of the adjacent body portions. For example, the low-elastic-modulus connection portion may be configured as a layer structure including an elastomeric resin material. For example, the low-elastic-modulus connection portion may have a thickness that is less than or equal to twice the thickness of the adjacent body portions. In this way, the elastic modulus of the low-elastic-modulus connection portion can be easily reduced.

In still another aspect of the pressure vessel, the low-elastic-modulus connection portion may be connected to the adjacent body portions by laser welding. In this way, the low-elastic-modulus connection portion can be easily integrated with the body portions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a liner before folding in the upper portion of the figure, and a liner after folding in the lower portion of the figure;

FIG. 2 is a cross-sectional view of a target region 104 taken along line II-II in FIG. 1;

FIG. 3 is a cross-sectional view of a target region 112 taken along line III-III in FIG. 1; and

FIG. 4 shows a state in which the target region 104 and a target region 110 are joined together by laser welding at the location indicated by IV in FIG. 1.

### DETAILED DESCRIPTION OF EMBODIMENTS

Hereinafter, a pressure vessel disclosed in the present specification will be described with reference to the drawings as appropriate. Examples of the fluid to be stored in the pressure vessel include, but are not limited to, hydrogen, natural gas, helium, dimethyl ether, liquefied petroleum gas, and xenon. These fluids may be pressurized.

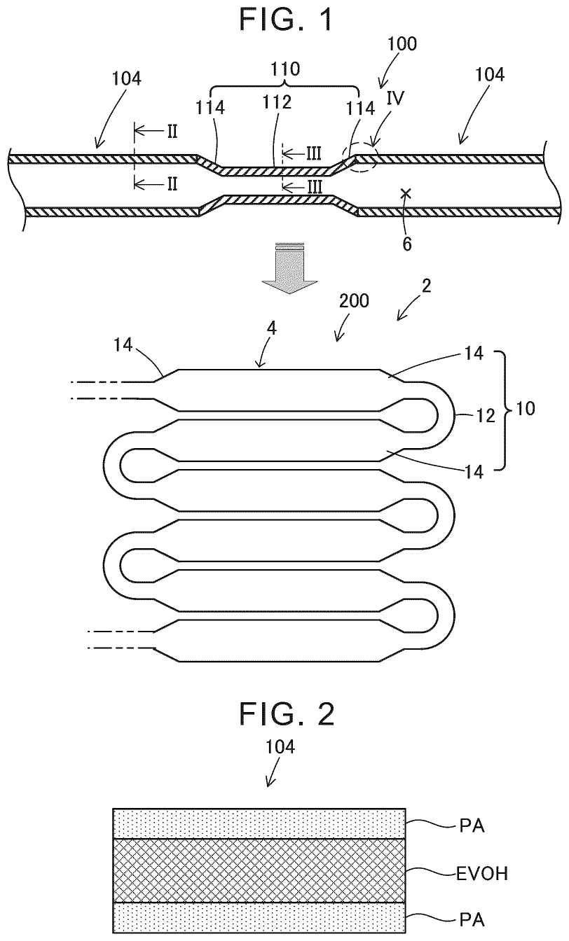

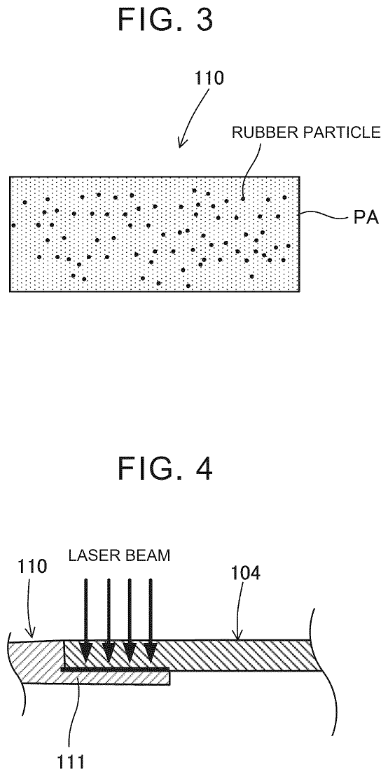

The upper portion of FIG. 1 shows a liner 100 that is a workpiece before bending, and the lower portion of FIG. 1 shows a liner 200, after bending, placed in a pressure vessel 2. FIGS. 2 and 3 show an example of the cross-sectional structures of a target region 104 and a target region 110 of the liner 100 before folding, respectively. In the following description, the liner 100 before bending will be described first, and then the liner 200 after bending will be described.

The pressure vessel 2 typically includes, on the surface of the liner 200, a braided structure made of a fiber-reinforced plastic material such as CFRP. For convenience of explanation, the liners 100, 200 will be described below, and the braided structure is not shown in the figures.

As shown in the upper portion of FIG. 1, the liner 100 includes a target region 104 corresponding to a body portion 4 of the pressure vessel 2, and a target region 110 corresponding to a connection portion 10 of the pressure vessel 2. In the liner 100, a plurality of the target regions 104 and a plurality of the target regions 110 are alternately connected. The liner 100 is intended to be folded at the target regions 110. The body portion 4 and the connection portion 10 of the pressure vessel 2 are examples of the body portion and the low-elastic-modulus connection portion disclosed in the present specification, respectively.

The target region 104 corresponding to the body portion 4 has an elongated tubular shape, and includes, inside, a space 6 that primarily serves as a fluid storage chamber. The target region 104 has a predetermined outer diameter and thickness.

The target region 104 is configured to exhibit a predetermined rigidity and mechanical strength. Examples of the material for the target region 104 include one or more resin materials selected from polyamide (PA), ethylene vinyl alcohol (EVOH), high-density polyethylene (HDPE), ethylene vinyl acetate (EVA), and linear low-density polyethylene (LLDPE). The target region 104 has a single-layer or multilayer structure of such a resin material or materials. For example, FIG. 2 shows a three-layer structure of a PA layer, an EVOH layer, and another PA layer as an example of the material and layer structure of the target region 104.

The target region 110 corresponding to the connection portion 10 is connected in series with the space 6 of the target region 104 so as to be in fluid communication therewith. The target region 110 has a substantially tubular shape and includes a target region 112 and two target regions 114. The target region 112 corresponds to a bent portion 12 in the connection portion 10. The target regions 114 correspond to two tapered portions 14 in the connection portion 10. The target region 110 is configured as an integrally molded body in which the target region 112 and the two target regions 114 are made of the same resin material or materials and layer structure.

The target region 112 has a straight tubular shape with an outer diameter smaller than that of the target region 104 and a predetermined thickness. The target region 112 has an outer diameter that is, for example, 60% or less, 50% or less, or 40% or less, and for example, 30% or more of the outer diameter of the target region 104. The target region 114 has a truncated conical shape that expands from the target region 112 to the outer diameter of the target region 104, in order to connect the target region 112 to the target region 104.

The target region 110 is configured to have a lower elastic modulus than the target region 104 in order to facilitate bending. Therefore, the thickness of the target region 110, particularly the thickness of the target region 112, can be set as follows. For example, the thickness of the target region 112 is about twice or less, about 1.5 times or less, about 1.2 times or less, about 1.0 times or less, about 0.8 times or less, about 0.6 times or less, about 0.4 times or less, or about 0.2 times the thickness of the target region 104.

The material and layer structure of the target region 110 may be different from those of the target region 104 such that the target region 110 have a lower elastic modulus than the target region 104. Although the material for the target region 110 may be, for example, the same as that for the target region 104, the target region 110 has, for example, a single-layer or multilayer structure of either or both of PA and EVOH.

In order to allow the target region 110 to have an intended elastic modulus lower than that of the target region 104, the following configurations may be adopted regarding the material and layer structure of the target region 110. These configurations may be combined as appropriate.

(1) The same resin material(s) and multilayer structure as those of the target region 104, but with a reduced overall thickness. (2) The same resin material(s) and multilayer structure as those of the target region 104, but with a reduced thickness of at least one specific layer such as EVOH. (3) A structure using a resin material layer(s) common with the target region 104, but constituted by a reduced number of layers or a single layer. (4) The same resin material(s) and multilayer structure as those of the target region 104, but with an elastomer material added to at least one resin material layer such as a PA layer. (5) A structure using a resin material layer(s) common with the target region 104, but constituted by a reduced number of layers or a single layer, including a PA layer containing an elastomer material. The target region 110 may additionally include a resin material different from the resin material(s) of the target region 104.

Examples of the elastomer material include known rubbers such as butyl rubber, and thermoplastic elastomer resin materials such as styrene block copolymers, thermoplastic polyurethanes, thermoplastic polyolefins, and polyamide elastomers.

Configuring the target region 110, throughout its entire length, as a layer structure including a resin material or materials that are the same as or common with those of the adjacent target regions 104 may make it possible to maintain the functions desired for the liner 100 while achieving a lower elastic modulus, which facilitates setting of the forming conditions for the bending process. Additionally, the target region 110 having a layered structure including an elastomeric resin material may also make it possible to maintain the functions desired for the liner 100 while achieving a lower elastic modulus.

For example, FIG. 3 illustrates an example of a multilayer structure of the target region 110, showing a single-layer structure of a PA layer in which rubber particles as an elastomer material are dispersed.

The elastic modulus of the target region 110 is lower than that of the target region 104. For example, when the elastic modulus of the target region 104 is taken as 100%, the elastic modulus of the target region 110 may be about 95% or less, about 90% or less, about 80% or less, about 60% or less, about 50% or less, about 40% or less, about 30% or less, about 20% or less, or about 10% or less of the elastic modulus of the target region 104. The elastic moduli of the target regions 104, 110 can be obtained by the following method. Test specimens of predetermined size are cut from each region, and tensile tests are performed under the same or equivalent test conditions and methods. For each specimen, strain (increase in gauge length/initial gauge length) and stress (load/cross-sectional area) are measured, and the ratio of stress to strain is taken as the elastic modulus.

To achieve a lower elastic modulus in the target region 110 than in the target region 104, various configurations can be combined as appropriate regarding the adjustment of the thickness of the target region 110 and the material and layer structure thereof as described above.

Both the target region 104 and the target region 110 are molded as hollow molded products using a known molding method such as extrusion molding, blow molding, vacuum forming, or pressure forming.

The target region 110 is connected to the target region 104 by, for example, laser welding, infrared welding, or adhesion. FIG. 4 is an enlarged view showing a state in which the target region 110 is joined to the target region 104 by laser welding. When a laser beam is used for joining, the target region 104 is transparent to the laser beam, and the target region 110 includes a laser-absorbing material such as carbon black that can absorb the laser beam and generate heat. As shown in FIG. 4, the target region 114 of the target region 110 includes an edge portion 111 extending to abut against the inner wall of the target region 104. After the target region 110 is fitted to the target region 104 via the edge portion 111, a laser beam is directed from outside the target region 104 toward the edge portion 111. Most of the laser beam passes through the target region 104. The edge portion 111 absorbs the laser beam and generates heat. This heat causes the interface between the target region 104 and the edge portion 111 to melt and fuse together.

The liner 100 before bending is then bent as shown in the lower portion of FIG. 1. Before the bending process, a braided structure (not shown) is mounted on the liner 100. The liner 100 is sequentially bent at the target regions 112 of the target regions 110 by, for example, approximately 180° by a known bending device such that the target regions 104 become folded. As a result, the pressure vessel 2, or the liner 200, is obtained.

The liner 200 thus obtained includes the body portions 4 obtained from the target regions 104 and the connection portions 10 obtained from the target regions 110. Each connection portion 10 includes the bent portion 12 obtained by bending the target region 112 and the tapered portions 14 obtained from the target regions 114. The liner 200 has the same configuration as the liner 100 except that the bent portion 12 corresponding to the target region 112 is bent. That is, the thicknesses, materials, and layer structures of the body portion 4, the connection portion 10, and the bent portion 12 of the liner 200 are the same as those of the liner 100. The thicknesses and elastic moduli of the body portion 4 and the connection portion 10 of the liner 200 can be measured in the same manner as that described above for the liner 100 by the method described above, and can exhibit the same characteristic values.

Since such a liner 200 includes the connection portion 10 that is separate from the body portion 4 and that has a lower elastic modulus than the body portion 4, bending is facilitated. This reduces a decrease in productivity during the bending process and the occurrence of collapse due to poor bendability. The body portion 4 has desired strength, rigidity, shape, etc., while the connection portion 10 allows smooth fluid flow and achieves sufficient compactness without increasing its volume.

In the liner 200, the connection portion 10 including the bent portion 12 and the tapered portions 14 is integrally molded from the same material and layer structure. Therefore, the manufacturing process of the liner 200 etc. is not complicated. Furthermore, the connection portion 10 is a layer structure including a resin material or materials that are the same as or common with those of the body portion 4, namely a layer structure using the same resin materials (PA/EVOH/PA) as the body portion 4, including an elastomer resin material in part of the layers (PA layer), and having a reduced thickness in part of the layers (EVOH layer). Accordingly, excellent bendability can be achieved while ensuring functionality as the pressure vessel 2.

In the above description, it is assumed that all the connection portions 10 are the low-elastic-modulus connection portions disclosed in the present specification. However, the present disclosure is not limited to this. Even when at least one of the connection portions 10 is a low-elastic-modulus connection portion, the effects can still be realized in that connection portion.

The above disclosure of the present specification also provides the liner 100 before bending and a method for manufacturing the liner 200 or the pressure vessel 2 using the liner 100.

The technical elements described in the present specification or illustrated in the drawings exhibit technical utility either individually or in various combinations, and are not limited to the combinations set forth in the claims as filed. In addition, the techniques illustrated in the present specification or the drawings may simultaneously achieve a plurality of objects, and achieving even one of these objects alone provides technical utility.

What is claimed is:

1. A pressure vessel configured to store fluid, the pressure vessel comprising a liner for the pressure vessel, wherein:
the liner includes a plurality of body portions and a plurality of connection portions, each of the body portions being in a form of an elongated tubular body, and each of the connection portions connecting two adjacent body portions out of the body portions in series and being configured to be bent to fold the body portions; and
the connection portions include at least one low-elastic-modulus connection portion that is separate from the adjacent body portions and that has a lower elastic modulus than the adjacent body portions.

2. The pressure vessel according to claim 1, wherein the low-elastic-modulus connection portion includes a bent portion and tapered portions located on both sides of the bent portion and directly connected to the adjacent body portions, and the low-elastic-modulus connection portion is configured, throughout an entire length of the low-elastic-modulus connection portion, as a layer structure including a resin material that is the same as or common with a resin material of the adjacent body portions.

3. The pressure vessel according to claim 2, wherein the low-elastic-modulus connection portion is configured as a layer structure including an elastomeric resin material.

4. The pressure vessel according to claim 3, wherein the low-elastic-modulus connection portion has a thickness that is less than or equal to twice a thickness of the adjacent body portions.

5. The pressure vessel according to claim 1, wherein the low-elastic-modulus connection portion is connected to the adjacent body portions by laser welding.
